(19) United States
(12) Patent Application Publication
(10) Pub. No.: US 2004/0017813 A1
(43) Pub. Date: Jan. 29, 2004

(54) Transmitting data from a plurality of virtual channels via a multiple processor device

(76) Inventors: Manu Gulati, Santa Clara, CA (US); Laurent Moll, Saratoga, CA (US); James Keller, Redwood City, CA (US)

Correspondence Address: GARLICK HARRISON & MARKISON LLP, P.O. BOX 160727, AUSTIN, TX, 78716-0727, US

(21) Appl. No.: 10/356,348

(22) Filed: Jan. 31, 2003

Related U.S. Application Data
(60) Provisional application No. 60/380,740, filed on May 15, 2002.
(60) Provisional application No. 60/419,040, filed on Oct. 16, 2002.

(51) Int. Cl. H04L 12/28

(52) U.S. Cl. 370/395.4; 370/462

(57) ABSTRACT

A multiple processor device schedules data from at least one of a plurality of virtual channels for transmission during a 1^{st} transmission cycle. The multiple processor device then determines a storage location for the data of the virtual channel during a 2^{nd} transmission cycle to produce a determined storage location. The multiple processor device then stores the data of the virtual channel in the determined storage location during a 3^{rd} transmission cycle. The multiple processor device then packetizes, during a 4^{th} transmission cycle, the stored data in accordance with a 1^{st} or 2^{nd} transmission protocol (e.g., HT, SPI, et cetera) to produce a packetized transmission.

The present application claims priority under 35 U.S.C. 119(e) to the following applications, each of which is incorporated herein for all purposes:

(1) provisional patent application entitled SYSTEM ON A CHIP FOR NETWORKING, having an application No. of 60/380,740, and a filing date of May 15, 2002; and

(2) provisional patent application having the same title as above, having an application No. of 60/419,040, and a filing date of Oct. 16, 2002.

### BACKGROUND OF THE INVENTION

1. Technical Field of the Invention

The present invention relates generally to data communications and more particularly to high-speed wired data communications.

2 Description of Related Art

As is known, communication technologies that link electronic devices are many and varied, servicing communications via both physical media and wirelessly. Some communication technologies interface a pair of devices, other communication technologies interface small groups of devices, and still other communication technologies interface large groups of devices.

Examples of communication technologies that couple small groups of devices include buses within digital computers, e.g., PCI (peripheral component interface) bus, ISA (industry standard architecture) bus, an USB (universal serial bus), SPI (system packet interface) among others. One relatively new communication technology for coupling relatively small groups of devices is the HyperTransport (HT) technology, previously known as the Lightning Data Transport (LDT) technology (HyperTransport I/O Link Specification “HT Standard”). The HT Standard sets forth definitions for a high-speed, low-latency protocol that can interface with today's buses like AGP, PCI, SPI, 1394, USB 2.0, and 1 Gbit Ethernet as well as next generation buses including AGP 8x, Infiniband, PCI-X, PCI 3.0, and 10 Gbit Ethernet. HT interconnects provide high-speed data links between coupled devices. Most HT enabled devices include at least a pair of HT ports so that HT enabled devices may be daisy-chained. In an HT chain or fabric, each coupled device may communicate with each other coupled device using appropriate addressing and control. Examples of devices that may be HT chained include packet data routers, server computers, data storage devices, and other computer peripheral devices, among others.

Of these devices that may be HT chained together, many require significant processing capability and significant memory capacity. Thus, these devices typically include multiple processors and have a large amount of memory. While a device or group of devices having a large amount of memory and significant processing resources may be capable of performing a large number of tasks, significant operational difficulties exist in coordinating the operation of multiple processors. While each processor may be capable of executing a large number operations in a given time period, the operation of the processors must be coordinated and memory must be managed to assure coherency of cached copies. In a typical multi-processor installation, each processor typically includes a Level 1 (L1) cache coupled to a group of processors via a processor bus. The processor bus is most likely contained upon a printed circuit board. A Level 2 (L2) cache and a memory controller (that also couples to memory) also typically couples to the processor bus. Thus, each of the processors has access to the shared L2 cache and the memory controller and can snoop the processor bus for its cache coherency purposes. This multi-processor installation (node) is generally accepted and functions well in many environments.

However, network switches and web servers often times require more processing and storage capacity than can be provided by a single small group of processors sharing a processor bus. Thus, in some installations, a plurality processor/memory groups (nodes) is sometimes contained in a single device. In these instances, the nodes may be rack mounted and may be coupled via a back plane of the rack. Unfortunately, while the sharing of memory by processors within a single node is a fairly straightforward task, the sharing of memory between nodes is a daunting task. Memory accesses between nodes are slow and severely degrade the performance of the installation. Many other shortcomings in the operation of multiple node systems also exist. These shortcomings relate to cache coherency operations, interrupt service operations, etc.

While HT links provide high-speed connectivity for the above-mentioned devices and in other applications, they are inherently inefficient in some ways. For example, in a “legal” HT chain, one HT enabled device serves as a host bridge while other HT enabled devices serve as dual link tunnels and a single HT enabled device sits at the end of the HT chain and serves as an end-of-chain device (also referred to as an HT “cave”). According to the HT Standard, all communications must flow through the host bridge, even if the communication is between two adjacent devices in the HT chain. Thus, if an end-of-chain HT device desires to communicate with an adjacent HT tunnel, its transmitted communications flow first upstream to the host bridge and then flow downstream from the host bridge to the adjacent destination device. Such communication routing, while allowing the HT chain to be well managed, reduces the overall throughput achievable by the HT chain, increases latency of operations, and reduces concurrency of transactions.

Applications, including the above-mentioned devices, that otherwise benefit from the speed advantages of the HT chain are hampered by the inherent delays and transaction routing limitations of current HT chain operations. Because all transactions are serviced by the host bridge and the host a limited number of transactions it can process at a given time, transaction latency is a significant issue for devices on the HT chain, particularly so for those devices residing at the far end of the HT chain, i.e., at or near the end-of-chain device. Further, because all communications serviced by the HT chain, both upstream and downstream, must share the bandwidth provided by the HT chain, the HT chain may have insufficient total capacity to simultaneously service all required transactions at their required bandwidth(s). Moreover, a limited number of transactions may be addressed at any time by any one device such as the host, e.g., 32 transactions (2**5). The host bridge is therefore limited in the number of transactions that it may have outstanding at any time and the host bridge may be unable to service all required transactions satisfactorily. Each of these operational limitations affects the ability of an HT chain to service the communications requirements of coupled devices.

Further, even if an HT enabled device were incorporated into a system (e.g., an HT enabled server, router, etc. were incorporated into an circuit-switched system or packet-switched system), it would be required to interface with a legacy device that uses an older communication protocol. For example, if a line card were developed with HT ports, the line card would need to communicate with legacy line cards that include SPI ports.

Therefore, a need exists for methods and/or apparatuses for interfacing devices using one or more communication protocols in one or more configurations while overcoming the bandwidth limitations, latency limitations, limited concurrency, and other limitations associated with the use of a high-speed HT chain.

### BRIEF SUMMARY OF THE INVENTION

The transmitting of data from a plurality of virtual channels via a multiple processor device of the present invention substantially meets these needs and others. In an embodiment, the multiple processor device schedules data from at least one of a plurality of virtual channels for transmission during a 1^{st} transmission cycle. The multiple processor device then determines a storage location for the data of the virtual channel during a 2^{nd} transmission cycle to produce a determined storage location. The multiple processor device then stores the data of the virtual channel in the determined storage location during a 3^{rd} transmission cycle. The multiple processor device then packetizes, during a 4^{th} transmission cycle, the stored data, typically with other stored data, in accordance with a 1^{st} or 2^{nd} transmission protocol (e.g., HT, SPI, et cetera) to produce a packetized transmission. With such a method and apparatus, the multiple processor device may interface with a plurality of other multiple processor devices using one or more communication protocols, be configured in one or more configurations while overcoming bandwidth limitations, latency limitations and other limitations associated with the use of a high speed chain.

### BRIEF DESCRIPTION OF THE SEVERAL VIEWS OF THE DRAWINGS

FIG. 1 is a schematic block diagram of a processing system in accordance with the present invention;

FIG. 2 is a schematic block diagram of an alternate processing system in accordance with the present invention;

FIG. 3 is a schematic block diagram of another processing system in accordance with the present invention;

FIG. 4 is a schematic block diagram of a multiple processor device in accordance with the present invention;

FIG. 5 is a graphical representation of transporting data between devices in accordance with the present invention;

FIG. 6 is a schematic block diagram of a transmit media access module in accordance with the present invention;

FIG. 7 is a graphical representation of the processing performed by the transmit media access control module of FIG. 6;

FIG. 8 is a schematic block diagram of an alternate transmit media access control module in accordance with the present invention; and

FIG. 9 is a logic diagram of a method for transmitting data from a plurality of virtual channels via a multiple processor device in accordance with the present invention.

### DETAILED DESCRIPTION OF THE INVENTION

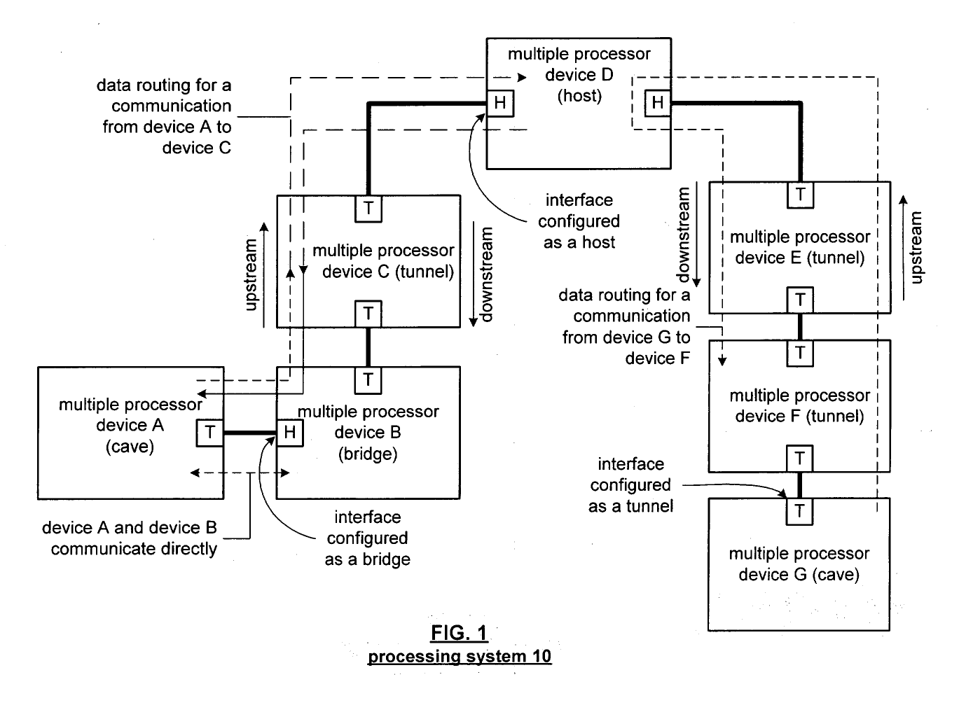

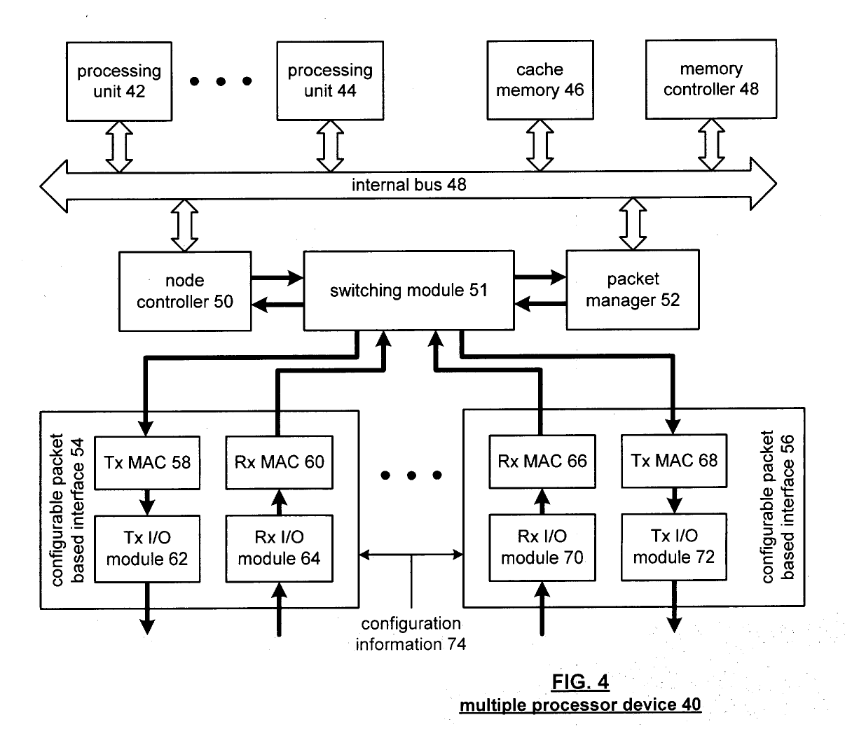

FIG. 1 is a schematic block diagram of a processing system 10 that includes a plurality of multiple processor devices A-G. Each of the multiple processor devices A-G include at least two interfaces, which, in this illustration, are labeled as T for tunnel functionality or H for host or bridge functionality. The details of the multiple processor devices A-G will be described in greater detail with reference to FIG. 4.

In this example of a processing system 10, multiple processor device D is functioning as a host to support two primary chains. The 1^{st} primary chain includes multiple processor device C, which is configured to provide a tunnel function, and multiple processor device B, which is configured to provide a bridge function. The other primary chain supported by device D includes multiple processor devices E and F, which are each configured to provide tunneling functionality, and multiple processor device G, which is configured to provide a cave function. The processing system 10 also includes a secondary chain that includes multiple processor devices A and B, where device A is configured to provide a cave function. Multiple processor device B functions as the host for the secondary chain. By convention, data from the devices (i.e., nodes) in a chain to the host device is referred to as upstream data and data from the host device to the node devices is referred to as downstream data.

In general, when a multiple processor device is providing a tunneling function, it passes, without interpretation, all packets received from downstream devices (i.e., the multiple processor devices that, in the chain, are further away from the host device) to the next upstream device (i.e., an adjacent multiple processor device that, in the chain, is closer to the host device). For example, multiple processor device E provides all upstream packets received from downstream multiple processor devices F and G to host device D without interpretation, even if the packets are addressing multiple processor device E. The host device D modifies the upstream packets to identify itself as the source of packets and sends the modified packets downstream along with any packets that it generated. As the multiple processor devices receive the downstream packets, they interpret the packet to identify the host device as the source and to identify a destination. If the multiple processor device is not the destination, it passes the downstream packets to the next downstream node. For example, packets received from the host device D that are directed to the multiple processor device E will be processed by the multiple processor device E, but device E will pass packets for devices F and G. The processing of packets by device E includes routing the packets to a particular processing unit within device E, routing to local memory, routing to external memory associated with device E, et cetera.

In this configuration, if multiple processor device G desires to send packets to multiple processor device F, the packets would traverse through devices E and F to host device D. Host device D modifies the packets identifying the multiple processor device D as the source of the packets and provides the modified packets to multiple processor device E, which would in turn forward them to multiple processor device F. A similar type of packet flow occurs for multiple processor device B communicating with multiple processor device C, for communications between devices G and E, and for communications between devices E and F.

For the secondary chain, devices A and B can communication directly, i.e., they support peer-to-peer communications therebetween. In this instance, the multiple processor device B has one of its interfaces (H) configured to provide a bridge function. Accordingly, the bridge functioning interface of device B interprets packets it receives from device A to determine the destination of the packet. If the destination is local to device B (i.e., meaning the destination of the packet is one of the modules within multiple processor device B or associated with multiple processor device B), the H interface processes the received packet. The processing includes forwarding the packet to the appropriate destination within, or associated with, device B.

If the packet is not destined for a module within device B, multiple processor device B modifies the packet to identify itself as the source of the packets. The modified packets are then forwarded to the host device D via device C, which is providing a tunneling function. For example, if device A desires to communicate with device C; device A provides packets to device B and device B modifies the packets to identify itself as the source of the packets. Device B then provides the modified packets to host device D via device C. Host device D then, in turn, modifies the packets to identify itself as the source of the packets and provides the again modified packets to device C, where the packets are subsequently processed. Conversely, if device C were to transmit packets to device A, the packets would first be sent to host D, modified by device D, and the modified packets would be provided back to device C. Device C, in accordance with the tunneling function, passes the packets to device B. Device B interprets the packets, identifies device A as the destination, and modifies the packets to identify device B as the source. Device B then provides the modified packets to device A for processing thereby.

In the processing system 10, device D, as the host, assigns a node ID (identification code) to each of the other multiple processor devices in the system. Multiple processor device D then maps the node ID to a unit ID for each device in the system, including its own node ID to its own unit ID. Accordingly, by including a bridging functionality in device B, in accordance with the present invention, the processing system 10 allows for interfacing between devices using one or more communication protocols and may be configured in one or more configurations while overcoming bandwidth limitations, latency limitations and other limitations associated with the use of high speed HyperTransport chains. Such communication protocols include, but are not limited to, a HyperTransport protocol, system packet interface (SPI) protocol and/or other types of packet-switched or circuit-switched protocols.

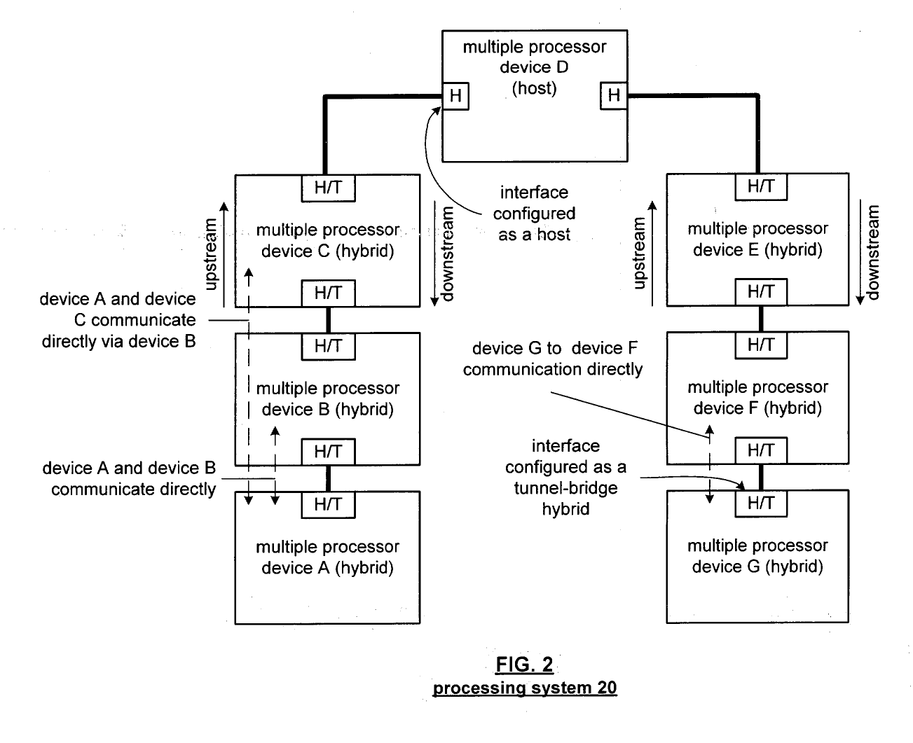

FIG. 2 is a schematic block diagram of an alternate processing system 20 that includes a plurality of multiple processor devices A-G. In this system 20, multiple processor device D is the host device while the remaining devices are configured to support a tunnel-bridge hybrid interfacing functionality. Each of multiple processor devices A-C and E-G have their interfaces configured to support the tunnel-bridge hybrid (H/T) mode. With the interfacing configured in this manner, peer-to-peer communications may occur between multiple processor devices in a chain. For example, multiple processor device A may communicate directly with multiple processor device B and may communicate with multiple processor device C, via device B, without routing packets through the host device D. For peer-to-peer communication between devices A and B, multiple processor device B interprets the packets received from multiple processor device A to determine whether the destination of the packet is local to multiple processor device B. With reference to FIG. 4, a destination associated with multiple processor device B may be any one of the plurality of processing units 42-44, cache memory 46 or system memory accessible through the memory controller 48. Returning back to the diagram of FIG. 2, if the packets received from device A are destined for a module within device B, device B processes the packets by forwarding them to the appropriate module within device B. If the packets are not destined for device B, device B forwards them, without modifying the source of the packets, to multiple processor device C. As such, for this example, the source of packets remains device A.

The packets received by multiple processor device C are interpreted to determine whether a module within multiple processor device C is the destination of the packets. If so, device C processes them by forwarding the packets to the appropriate module within, or associated with, device C. If the packets are not destined for a module within device C, device C forwards them to the multiple processor device D. Device D modifies the packets to identify itself as the source of the packets and provides the modified packets to the chain including devices E-G. Note that device C, having interpreted the packets, passes only packets that are destined for a device other than itself in the upstream direction. Since device D is the only upstream device for the primary chain that includes device C, device D knows, based on the destination address, that the packets are for a device in the other primary chain.

Devices E-G, in order, interpret the modified packets to determine whether it is a destination of the modified packets. If so, the device processes the packets. If not, the device routes the packets to the next device in chain. In addition, devices E-G support peer-to-peer communications in a similar manner as devices A-C. Accordingly, by configuring the interfaces of the devices to support a tunnel-bridge hybrid function, the source of the packets is not modified (except when the communications are between primary chains of the system), which enables the devices to use one or more communication protocols (e.g., HyperTransport, system packet interface, et cetera) in a peer-to-peer configuration that substantially overcomes the bandwidth limitations, latency limitations and other limitations associated with the use of a conventional high-speed HyperTransport chain.

In general, a device configured as a tunnel-bridge hybrid has knowledge about which direction to send requests. For example, for device C to communicate with device A, device C knows that device A is downstream and is coupled to device B. As such, device C sends packets to device B for forwarding to device A as opposed to a traditional tunnel function, where device C would have to send packets for device A to device D, where device D would provide them back downstream after redefining itself as the source of the packets. To facilitate the more direct communications, each device maintains the address ranges, in range registers, for each link (or at least one of its links) and enforces ordering rules regardless of the Unit ID across its interfaces.

To facilitate the tunnel-hybrid functionality, since each device receives a unique Node ID, request packets are generated with the device's unique Node ID in the a Unit ID field of the packet. For packets that are forwarded upstream (or downstream), the Unit ID field and the source ID field of the request packets are preserved. As such, when the target device receives a request packet, the target device may accept the packet based on the address.

When the target device generates a response packet in response to a request packet(s), it uses the unique Node ID of the requesting device rather than the Node ID of the responding device. In addition, the responding device also preserves the Source Tag of the requesting device such that the response packet includes the Node ID and Source Tag of the requesting device. This enables the response packets to be accepted based on the Node ID rather than based on a bridge bit or direction of travel of the packet.

For a device to be configured as a tunnel-bridge hybrid,, it export, at configuration of the system 20, a type 1 header (i.e., a bridge header in accordance with the HT specification) in addition to, or in place of, a type 0 header (i.e., a tunnel header in accordance with the HT specification). In response to the type 1 header, the host device programs the address range registers of the devices A-C and E-G regarding one or more links coupled to the devices. Once configured, the device utilizes the addresses in its address range registers to identify the direction (i.e., upstream link or downstream link) to send request packets and/or response packets to a particular device as described above.

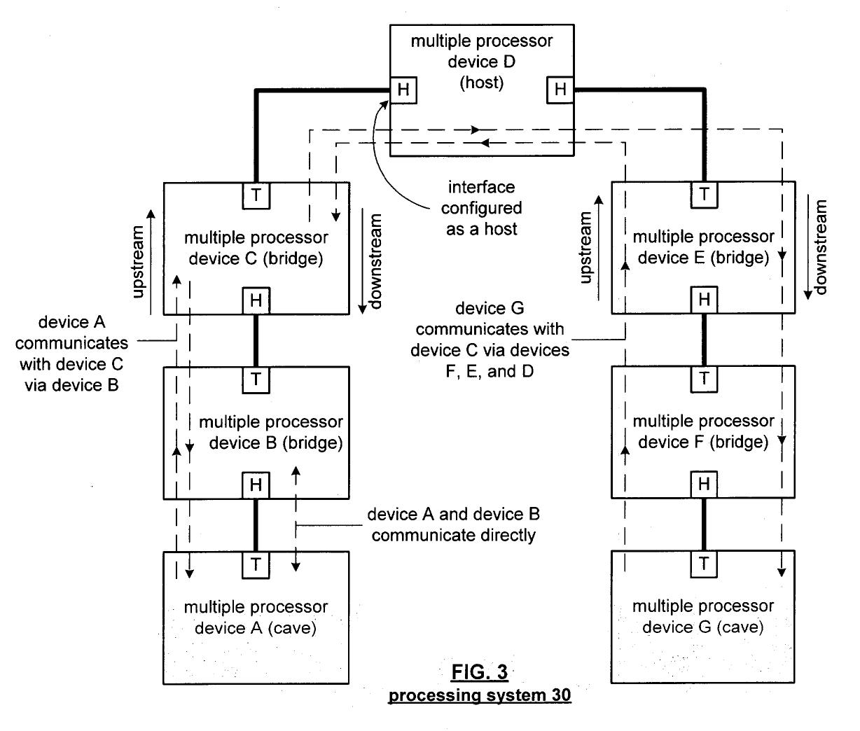

FIG. 3 is a schematic block diagram of processing system 30 that includes multiple processor devices A-G. In this embodiment, multiple processor device D is functioning as a host device for the system while the multiple processor devices B, C, E and F are configured to provide bridge functionality and devices A and G are configured to support a cave function. In this configuration, each of the devices may communicate directly (i.e., have peer-to-peer communication) with adjacent multiple processor devices via cascaded secondary chains. For example, device A may directly communicate with device B via a secondary chain therebetween, device B may communicate directly with device C via a secondary chain therebetween, device E may communicate directly with device F via a secondary chain therebetween, and device F may communicate directly with device G via a secondary chain therebetween. The primary chains in this example of a processing system exist between device D and device C and between device D and device E.

For communication between devices A and B, device B interprets packets received from device A to determine their destination. If device B is the destination, it processes it by providing it to the appropriate destination within, or associated with, device B. If a packet is not destined for device B, device B modifies the packet to identify itself as the source and forwards it to device C. Accordingly, if device A desires to communicate with device B, it does so directly since device B is providing a bridge function with respect to device A. However, for device A desires to communicate with device C, device B, as the host for the chain between devices A and B, modifies the packets to identify itself as the source of the packets. The modified packets are then routed to device C. To device C, the packets appear to be sourced from device B and not device A. For packets from device C to device A, device B modifies the packets to identify itself as the source of the packets and provides the modified packets to device A. In such a configuration, each device only knows that it is communicating with one device in the downstream direct and one device in the upstream direction. As such, peer-to-peer communication is supported directly between adjacent devices and is also supported indirectly (i.e., by modifying the packets to identify the host of the secondary chain as the source of the packets) between any devices in the system.

In any of the processing systems illustrated in FIGS. 1-3, the devices on one chain may communicate with devices on the other chain. An example of this is illustrated in FIG. 3 where device G may communicate with device C. As shown, packets from device G are propagated through devices D, E and F until they reach device C. Similarly, packets from device C are propagated through devices D, E and F until they reach device G. In the example of FIG. 3, the packets in the downstream direction and in the upstream direction are adjusted to modify the source of the packets. Accordingly, packets received from device G appear, to device C, to be originated by device D. Similarly, packets from device C appear, to device G, to be sourced by device F. As one of average skill in the art will appreciate, each device that is providing a host function or a bridge function maintains a table of communications for the chains it is the host to track the true source of the packets and the true destination of the packets.

FIG. 4 is a schematic block diagram of a multiple processor device 40 in accordance with the present invention. The multiple processor device 40 may be an integrated circuit or it may be constructed from discrete components. In either implementation, the multiple processor device 40 may be used as multiple processor device A-G in the processing systems illustrated in FIGS. 1-3.

The multiple processor device 40 includes a plurality of processing units 42-44, cache memory 46, memory controller 48, which interfaces with on and/or off-chip system memory, an internal bus 48, a node controller 50, a switching module 51, a packet manager 52, and a plurality of configurable packet based interfaces 54-56 (only two shown). The processing units 42-44, which may be two or more in numbers, may have a MIPS based architecture, to support floating point processing and branch prediction. In addition, each processing unit 42-44 may include a memory sub-system of an instruction cache and a data cache and may support separately, or in combination, one or more processing functions. With respect to the processing system of FIGS. 1-3, each processing unit 42-44 may be a destination within multiple processor device 40 and/or each processing function executed by the processing modules 42-44 may be a destination within the processor device 40.

The internal bus 48, which may be a 256 bit cache line wide split transaction cache coherent bus, couples the processing units 42-44, cache memory 46, memory controller 48, node controller 50 and packet manager 52 together. The cache memory 46 may function as an L2 cache for the processing units 42-44, node controller 50 and/or packet manager 52. With respect to the processing system of FIGS. 1-3, the cache memory 46 may be a destination within multiple processor device 40.

The memory controller 48 provides an interface to system memory, which, when the multiple processor device 40 is an integrated circuit, may be off-chip and/or on-chip. With respect to the processing system of FIGS. 1-3, the system memory may be a destination within the multiple processor device 40 and/or memory locations within the system memory may be individual destinations within the device 40. Accordingly, the system memory may include one or more destinations for the processing systems illustrated in FIGS. 1-3.

The node controller 50 functions as a bridge between the internal bus 48 and the configurable packet-based interfaces 54-56. Accordingly, accesses originated on either side of the node controller will be translated and sent on to the other. The node controller also supports the distributed shared memory model associated with the cache coherency non-uniform memory access (CC-NUMA) protocol.

The switching module 51 couples the plurality of configurable packet-based interfaces 54-56 to the node controller 50 and/or to the packet manager 52. The switching module 51 functions to direct data traffic, which may be in a generic format, between the node controller 50 and the configurable packet-based interfaces 54-56 and between the packet manager 52 and the configurable packet-based interfaces 54.. The generic format may include 8 byte data words or 16 byte data words formatted in accordance with a proprietary protocol, in accordance with asynchronous transfer mode (ATM) cells, in accordance with internet protocol (IP) packets, in accordance with transmission control protocol/internet protocol (TCP/IP) packets, and/or in general, in accordance with any packet-switched protocol or circuit-switched protocol.

The packet manager 52 may be a direct memory access (DMA) engine that writes packets received from the switching module 51 into input queues of the system memory and reads packets from output queues of the system memory to the appropriate configurable packet-based interface 54-56. The packet manager 52 may include an input packet manager and an output packet manager each having its own DMA engine and associated cache memory. The cache memory may be arranged as first in first out (FIFO) buffers that respectively support the input queues and output queues.

The configurable packet-based interfaces 54-56 generally function to convert data from a high-speed communication protocol (e.g., HT, SPI, etc.) utilized between multiple processor devices 40 and the generic format of data within the multiple processor devices 40. Accordingly, the configurable packet-based interface 54 or 56 may convert received HT or SPI packets into the generic format packets or data words for processing within the multiple processor device 40. In addition, the configurable packet-based interfaces 54 and/or 56 may convert the generic formatted data received from the switching module 51 into HT packets or SPI packets. The particular conversion of packets to generic formatted data performed by the configurable packet-based interfaces 54 and 56 is based on configuration information 74, which, for example, indicates configuration for HT to generic format conversion or SPI to generic format conversion.

Each of the configurable packet-based interfaces 54-56 includes a transmit media access controller (Tx MAC) 58 or 68, a receiver (Rx) MAC 60 or 66, a transmitter input/output (I/O) module 62 or 72, and a receiver input/output (I/O) module 64 or 70. In general, the transmit MAC module 58 or 68 functions to convert outbound data of a plurality of virtual channels in the generic format to a stream of data in the specific high-speed communication protocol (e.g., HT, SPI, etc.) format. The transmit I/O module 62 or 72 generally functions to drive the high-speed formatted stream of data onto the physical link coupling the present multiple processor device 40 to another multiple processor device. The transmit I/O module 62 or 72 is further described, and incorporated herein by reference, in co-pending patent application entitled MULTI-FUNCTION INTERFACE AND APPLICATIONS THEREOF, having an attorney docket number of BP 2389, and having the same filing date and priority date as the present application. The receive MAC module 60 or 66 generally functions to convert the received stream of data from the specific high-speed communication protocol (e.g., HT, SPI, etc.) format into data from a plurality of virtual channels having the generic format. The receive I/O module 64 or 70 generally functions to amplify and time align the high-speed formatted steam of data received via the physical link coupling the present multiple processor device 40 to another multiple processor device. The receive 1/O module 64 or 70 is further described, and incorporated herein by reference, in co-pending patent application entitled RECEIVER MULTI-PROTOCOL INTERFACE AND APPLICATIONS THEREOF, having an attorney docket number of BP 2389.1, and having the same filing date and priority date as the present application.

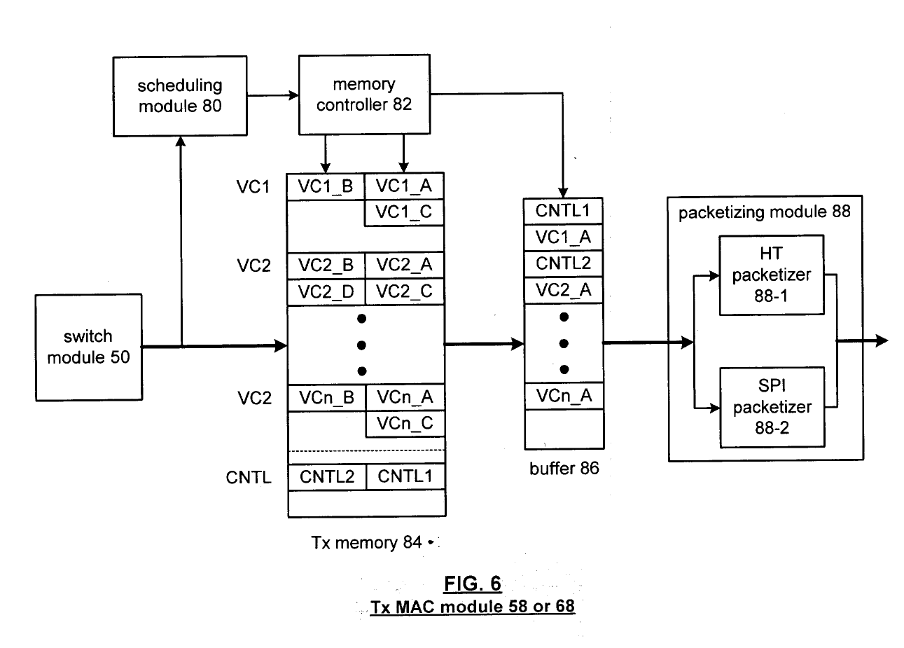

The transmit and/or receive MACs 58, 60, 66 and/or 68 may include, individually or in combination, a processing module and associated memory to perform its correspond functions. The processing module may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the processing module implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. The memory stores, and the processing module executes, operational instructions corresponding to the functionality performed by the transmitter MAC 58 or 68 as disclosed, and incorporated herein by reference, in co-pending patent application entitled TRANSMITTING DATA FROM A PLURALITY OF VIRTUAL CHANNELS VIA A MULTIPLE PROCESSOR DEVICE, having an attorney docket number of BP 2184.1 and having the same filing date and priority date as the present patent application and corresponding to the functionality performed by the receiver MAC module 60 or 66 as further described in FIGS. 6-10.

In operation, the configurable packet-based interfaces 54-56 provide the means for communicating with other multiple processor devices 40 in a processing system such as the ones illustrated in FIGS. 1, 2 or 3. The communication between multiple processor devices 40 via the configurable packet-based interfaces 54 and 56 is formatted in accordance with a particular high-speed communication protocol (e.g., HyperTransport (HT) or system packet interface (SPI)). The configurable packet-based interfaces 54-56 may be configured to support, at a given time, one or more of the particular high-speed communication protocols. In addition, the configurable packet-based interfaces 54-56 may be configured to support the multiple processor device 40 in providing a tunnel function, a bridge function, or a tunnel-bridge hybrid function.

When the multiple processor device 40 is configured to function as a tunnel-hybrid node, the configurable packet-based interface 54 or 56 receives the high-speed communication protocol formatted stream of data and separates, via the MAC module 60 or 68, the stream of incoming data into generic formatted data associated with one or more of a plurality a particular virtual channels. The particular virtual channel may be associated with a local module of the multiple processor device 40 (e.g., one or more of the processing units 42-44, the cache memory 46 and/or memory controller 48) and, accordingly, corresponds to a destination of the multiple processor device 40 or the particular virtual channel may be for forwarding packets to the another multiple processor device.

The interface 54 or 56 provides the generically formatted data words, which may comprise a packet, or portion thereof, to the switching module 51, which routes the generically formatted data words to the packet manager 52 and/or to node controller 50. The node controller 50, the packet manager 52 and/or one or more processing units 42-44 interprets the generically formatted data words to determine a destination therefor. If the destination is local to multiple processor device 40 (i.e., the data is for one of processing units 42-44, cache memory 46 or memory controller 48), the node controller 50 and/or packet manager 52 provides the data, in a packet format, to the appropriate destination. If the data is not addressing a local destination, the packet manager 52, node controller 50 and/or processing unit 42-44 causes the switching module 51 to provide the packet to one of the other configurable packet-based interfaces 54 or 56 for forwarding to another multiple processor device in the processing system. For example, if the data were received via configuration packet-based interface 54, the switching module 51 would provide the outgoing data to configurable packet-based interface 56. In addition, the switching module 51 provides outgoing packets generated by the local modules of processing module device 40 to one or more of the configurable packet-based interfaces 54-56.

The configurable packet-based interface 54 or 56 receives the generic formatted data via the transmitter MAC module 58 or 68. The transmitter MAC module 58, or 68 converts the generic formatted data from a plurality of virtual channels into a single stream of data. The transmitter input/output module 62 or 72 drives the stream of data on to the physical link coupling the present multiple processor device to another.

When the multiple processor device 40 is configured to function as a tunnel node, the data received by the configurable packet-based interfaces 54 from a downstream node is routed to the switching module 51 and then subsequently routed to another one of the configurable packet-based interfaces for transmission upstream without interpretation. For downstream transmissions, the data is interpreted to determine whether the destination of the data is local. If not, the data is routed downstream via one of the configurable packet-based interfaces 54 or 56.

When the multiple processor device 40 is configured as a bridge node, upstream packets that are received via a configurable packet-based interface 54 are modified via the interface 54, interface 56, the packet manager 52, the node controller 50, and/or processing units 42-44 to identify the current multiple processor device 40 as the source of the data. Having modified the source, the switching module 51 provides the modified data to one of the configurable packet-based interfaces for transmission upstream. For downstream transmissions, the multiple processor device 40 interprets the data to determine whether it contains the destination for the data. If so, the data is routed to the appropriate destination. If not, the multiple processor device 40 forwards the packet via one of the configurable packet-based interfaces 54 or 56 to a downstream device.

To determine the destination of the data, the node controller 50, the packet manager 52 and/or one of the processing units 42 or 44 interprets header information of the data to identify the destination (i.e., determines whether the target address is local to the device). In addition, a set of ordering rules of the received data is applied when processing the data, where processing includes forwarding the data, in packets, to the appropriate local destination or forwarding it onto another device. The ordering rules include the HT specification ordering rules and rules regarding non-posted commands being issued in order of reception. The rules further include that the interfaces are aware of whether they are configured to support a tunnel, bridge, or tunnel-bridge hybrid node. With such awareness, for every ordered pair of transactions, the receiver portion of the interface will not make a new transaction of an ordered pair visible to the switching module until the old transaction of an ordered pair has been sent to the switching module. The node controller, in addition to adhering to the HT specified ordering rules, treats all HT transactions as being part of the same input/output stream, regardless of which interface the transactions was received from. Accordingly, by applying the appropriate ordering rules, the routing to and from the appropriate destinations either locally or remotely is accurately achieved.

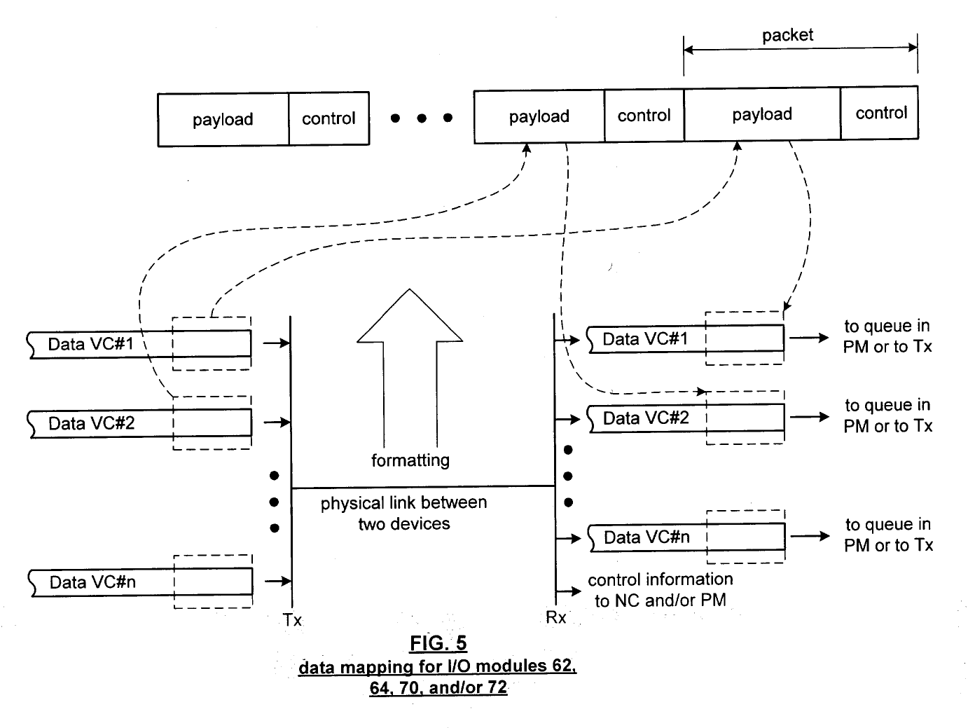

FIG. 5 is a graphical representation of the functionality performed by the node controller 50, the switching module 51, the packet manager 52 and/or the configurable packet-based interfaces 54 and 56. In this illustration, data is transmitted over a physical link between two devices in accordance with a particular high-speed communication protocol (e.g., HT, SPI-4, etc.). Accordingly, the physical link supports a protocol that includes a plurality of packets. Each packet includes a data payload and a control section. The control section may include header information regarding the payload, control data for processing the corresponding payload of a current packet, previous packet(s) or subsequent packet(s), and/or control data for system administration functions.

Within a multiple processor device, a plurality of virtual channels may be established. A virtual channel may correspond to a particular physical entity, such as processing units 42-44, cache memory 46 and/or memory controller 48, and/or to a logical entity such as a particular algorithm being executed by one or more of the processing modules 42-44, particular memory locations within cache memory 46 and/or particular memory locations within system memory accessible via the memory controller 48. In addition, one or more virtual channels may correspond to data packets received from downstream or upstream nodes that require forwarding. Accordingly, each multiple processor device supports a plurality of virtual channels. The data of the virtual channels, which is illustrated as data virtual channel number 1 (VC#1), virtual channel number 2 (VC#2) through virtual channel number N (VC#n) may have a generic format. The generic format may be 8 byte data words, 16 byte data words that correspond to a proprietary protocol, ATM cells, IP packets, TCP/IP packets, other packet switched protocols and/or circuit switched protocols.

As illustrated, a plurality of virtual channels is sharing the physical link between the two devices. The multiple processor device 40, via one or more of the processing units 42-44, node controller 50, the interfaces 54-56, and/or packet manager 52 manages the allocation of the physical link among the plurality of virtual channels. As shown, the payload of a particular packet may be loaded with one or more segments from one or more virtual channels. In this illustration, the 1^{st} packet includes a segment, or fragment, of virtual channel number 1. The data payload of the next packet receives a segment,; or fragment, of virtual channel number 2. The allocation of the bandwidth of the physical link to the plurality of virtual channels may be done in a round-robin fashion, a weighted round-robin fashion or some other application of fairness. The data transmitted across the physical link may be in a serial format and at extremely high data rates (e.g., 3.125 gigabits-per-second or greater), in a parallel format, or a combination thereof (e.g., 4 lines of 3.125 Gbps serial data).

At the receiving device, the stream of data is received and then separated into the corresponding virtual channels via the configurable packet-based interface, the switching module 51, the node controller 50, the interfaces 54-56, and/or packet manager 52. The recaptured virtual channel data is either provided to an input queue for a local destination or provided to an output queue for forwarding via one of the configurable packet-based interfaces to another device. Accordingly, each of the devices in a processing system as illustrated in FIGS. 1-3 may utilize a high speed serial interface, a parallel interface, or a plurality of high speed serial interfaces, to transceive data from a plurality of virtual channels utilizing one or more communication protocols and be configured in one or more configurations while substantially overcoming the bandwidth limitations, latency limitations, limited concurrency (i.e., renaming of packets) and other limitations associated with the use of a high speed HyperTransport chain. Configuring the multiple processor devices for application in the multiple configurations of processing systems is described in greater detail and incorporated herein by reference in co-pending patent application entitled MULTIPLE PROCESSOR INTEGRATED CIRCUIT HAVING CONFIGURABLE PACKET-BASED INTERFACES, having an attorney docket number of BP 2186, and having the same filing date and priority date as the present patent application.

FIG. 6 is a schematic block diagram of a transmit media access control (MAC) module 58 or 68. The transmit MAC module includes a scheduling module 80, memory controller 82, transmit memory 84, buffer 86 and a packetizing module 88. The packetizing module 88 may include a HyperTransport packetizer 88-1 and a SPI packetizer 88-2. As one of average skill in the art will appreciate, other types of packetizers may be incorporated within the packetizing module 88 to provide other types of packet-switched or circuit-switched protocol communications between multiple processor devices.

The transmit MAC module 58 or 68 receives data from a plurality of virtual channels via the switch module 50. The process of receiving the data from a virtual channel and packetizing it for transmission out on the physical link coupling the present multiple processor device to another takes approximately four processing cycles. A processing cycle may correspond to a single clock cycle or a plurality of clock cycles and, from processing cycle to processing cycle, the duration of the cycles may vary.

The scheduling module 80 interprets the data as it is being received from the switching module 50 during a 1^{st} transmission cycle to determine the ordering of the data for transmission via the transmit MAC module and also to facilitate the determination of a storage location. In particular, the scheduling module 80 utilizes a weighted round-robin algorithm implemented over short periods of times (e.g., about 10 cycles) to establish a scheduling order of the data received from the plurality of virtual channels. The weighting of the round-robin algorithm is based on priorities desired for particular virtual channels, pre-allocated bandwidth to the virtual channels, et cetera.

Based on an indication as to the identity of the current data to be stored from the scheduling module 80, the memory controller 82, in a 2^{nd} transmission cycle, determines the particular storage location within the transmit memory 84. As shown, the transmit memory 84 may be partitioned into memory blocks, where each memory block corresponds to a particular virtual channel and/or control information, which may correspond to one or more control virtual channels. As particularly shown, a portion of the transmit memory 84 is dedicated to the 1^{st} virtual channel (VC1), the 2^{nd} virtual channel (VC2) through the nth virtual channel (VCn) and also a section for control information (CNTL). During a 3 transmission cycle, the particular portion of the data transmitted by a virtual channel is stored in the appropriate location in the transmit memory 84.

Based on a scheduling order provided by the scheduling module 80, the memory controller 82 causes segments of data from the virtual channels and/or control segments to be read from the transmit memory 84 into buffer 86. The buffer 86 is a first-in-first-out random access memory device that provides the particular data segments to the packetizing module 88 for packetization.

The packetizing module 88 packetizes the data received from buffer 86 during a 4 transmission cycle. The packetization process may be done in accordance with the known HT packetizing process and/or the SPI packetizing process. The resulting packetized data is then transmitted via the transmit input/output module 62 or 72 onto the physical link coupling the present multiple processor device with another multiple processor device.

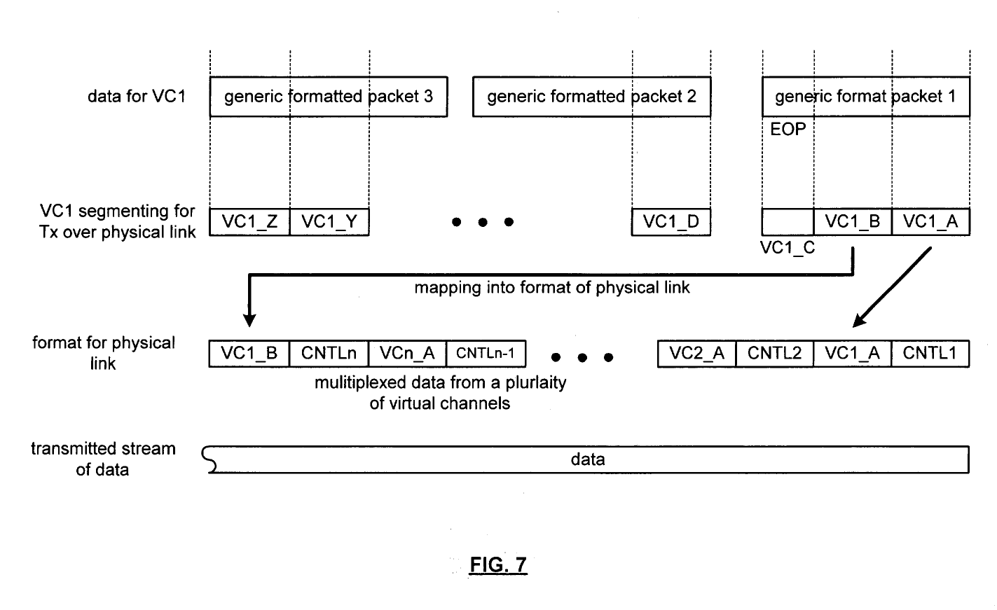

FIG. 7 is a graphical representation of the processing performed by the transmit MAC module of FIG. 6. As mentioned, the transmit MAC module receives data from a plurality of virtual channels. The data from the virtual channels may be organized as a plurality of packets having a generic format. The generic format may correspond to ATM cells, frame relay cells, IP packets, TCP/IP packets, and/or any other type of packet-switched and/or circuit-switched packetizing protocol. The illustration of FIG. 7 shows only data being transmitted by virtual channel 1. The scheduling module 80 effectively segments the packets for each of the virtual channels into a plurality of segments. For example, the 1^{st} packet from virtual channel 1 is segmented into three data segments, VC1_A, VC1_B, and VC1_C. The data contained within data segment VC1_A will include a start-of-packet indication for packet 1. The data segment VC1_C will include an end-of-packet indication for packet 1. The particular size of the data segments is based on the desired data path width within the multiple processor device. For example, the desired path width may be 8 bytes, 16 bytes, et cetera. Accordingly, each data segment of the data of a virtual channel is of the desired data path segment size. An exception to this occurs when the last segmentation of a packet is less than the desired data path segment size. This is illustrated with respect to the data segment VC1_C. In this example, to fully represent the remaining portion of packet 1 requires less than the desired data path segment size of, for example, 8 bytes or 16 bytes. Accordingly, the data segment VC1_C will be less than the desired data path segment size.

Having partitioned the data from a plurality of virtual channels into data segments corresponding to each of the plurality of virtual channels, the transmit MAC module maps the data segments into the corresponding format of the physical link via the packetizing module 88. As shown, the data packets for virtual channel 1 are distributed in a multiplexed manner among the other data segments from the other virtual channels. Intermixed with the data from the plurality of virtual channels is control information in accordance with the appropriate packetizing format (e.g., HT, SPI, et cetera). The data in the corresponding format is then transmitted as a stream of data via the transmit input/output module 62 or 72.

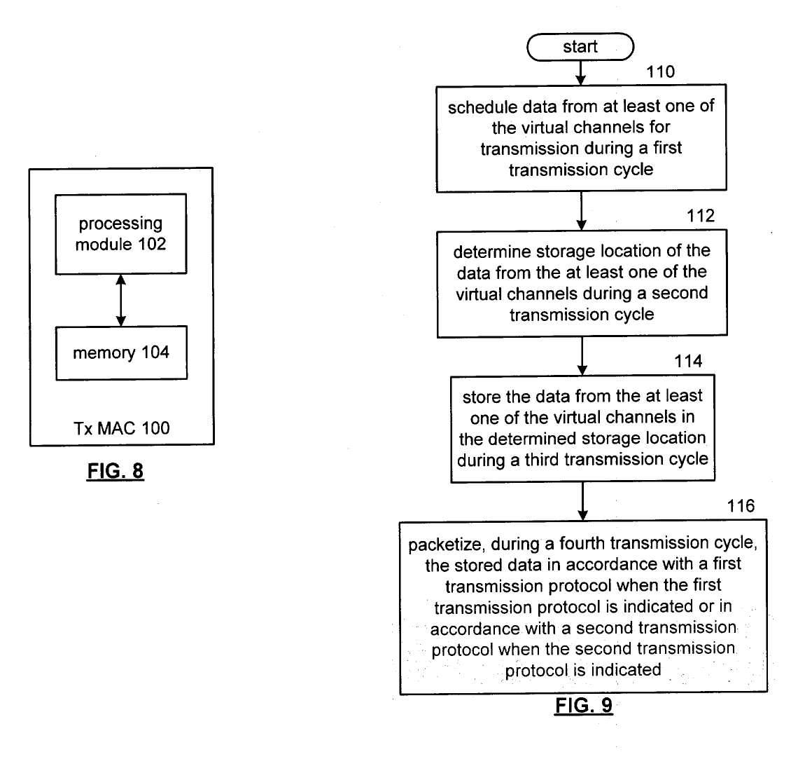

FIG. 8 is a schematic block diagram of an alternate transmit MAC module 100 that includes a processing module 102 and memory 104. The processing module 102 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 104 may be a single memory device or a plurality of memory devices. Such a memory device may be a read-only memory, random access memory, volatile memory, non-volatile memory, static memory, dynamic memory, flash memory, and/or any device that stores digital information. Note that when the processing module 102 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. The memory 104 stores, and the processing module 102 executes, operational instructions corresponding to at least some of the steps and/or functions illustrated in FIG. 9.

FIG. 9 is a logic diagram of a method for transmitting data from a plurality of virtual channels via a multiple processor device. The processing begins at Step 110 where a transmit MAC module of the multiple processor device schedules data from at least one of a plurality of virtual channels for transmission during a 1^{st} transmission cycle. The scheduling may be done by determining a weighting factor for each of the plurality of virtual channels and scheduling in accordance to the weighting factor in a round-robin fashion. Alternatively, the scheduling may be based on a bandwidth allocation policy where a particular virtual channel is allocated a particular portion of the corresponding bandwidth of the physical link coupling the present multiple processing device to another. The weighting factors utilized in the weighted round-robin process may be determined based on the desired reception parameters of a receiver of the data. For example, based on available receiver buffer space, the weighting factor may increase as the available buffer space increases and may decrease as the available buffer decreases. In addition, the bandwidth allocation policy may include a starvation policy that provides a priority to one of the virtual channels for transmission to prevent a loss of data. For example, each virtual channel has a corresponding amount of memory space within the transmit memory 84. If its allocated space is near full, priority should be given to that virtual channel such that if additional data of that virtual channel is received, memory space will be available.

The process then proceeds to Step 112 where the transmit MAC module determines a storage location of the data from the at least one of the plurality of virtual channels during a 2^{nd} transmission cycle. This may be done by managing a tail pointer of the transmit memory to indicate the particular storage location. A pluralty of tail pointers and head pointers may be utilizes for each corresponding section of memory for each virtual channel.

The process then proceeds to Step 114 where the transmit MAC module stores the data from the at least one virtual channel in the determined storage location during a ₃rd transmission cycle. The process then proceeds to Step 116 where the transmit MAC module packetizes, during a 4^{th} transmission cycle, the stored data in accordance with a 1s^{t} transmission protocol when the 1^{st} transmission protocol is indicated or in accordance with a 2^{nd} transmission protocol when the 2^{nd} transmission protocol is indicated. Note that the 1^{st} transmission protocol may be in accordance with a HyperTransport protocol and the 2^{nd} transmission protocol may be in accordance with a system packet interface protocol. Once the packets are produced, they may be stored in an elastic storage device that writes data into the device at one rate and reads data out at another rate.

The preceding discussion has presented a method and apparatus for transmitting data from a plurality of virtual channels via a multiple processor device. By utilizing such a methodology and apparatus, multiple processor devices may utilize one or more communication protocols and be configured in a variety of ways while overcoming bandwidth limitations, latency limitations, limited concurrency, and other limitations associated with the use of high-speed HT chains. As one of average skill in the art will appreciate, other embodiments may be derived from the teaching of the present invention, without deviating from the scope of the claims.

What is claimed is:

1. A method for transmitting data from a plurality of virtual channels, the method comprises:
scheduling data from at least one of the plurality of virtual channels for transmission during a first transmission cycle;
determining storage location of the data from the at least one of the virtual channels during a second transmission cycle to produce a determined storage location;
storing the data from the at least one of the virtual channels in the determined storage location during a third transmission cycle to produce stored data;
packetizing, during a fourth transmission cycle, the stored data in accordance with a first transmission protocol when the first transmission protocol is indicated; and
packetizing, during the fourth transmission cycle, the stored data in accordance with a second transmission protocol when the second transmission protocol is indicated.

2. The method of claim 1, wherein the scheduling further comprises at least one of:
determining a weighting factor for each of at least some of the plurality of virtual channels to produce a plurality of weighting factors, wherein each of the plurality of weighting factors indicates, for a respective one of the at least some of the plurality of virtual channels, a backlog of data to transmit, and wherein the at least some of the plurality of virtual channels includes the at least one of the plurality of virtual channels; and
selecting the at least one of plurality of virtual channels based on the plurality of weighting factors and an bandwidth allocation policy.

3. The method of claim 2, wherein the determining the weighting factor further comprises:
establishing the weighting factor for a particular one of the at least some of the plurality of virtual channels based on desired reception parameters of a receiver of the data from the particular one of the at least some of the plurality of virtual channels.

4. The method of claim 2, wherein the bandwidth allocation policy further comprises at least one of:
weighted round robin allocation among the plurality of virtual channels;
starvation allocation policy that provides priority to one of the plurality of virtual channels having a potential loss of data; and
receiver availability allocation policy that provides priority to one of the plurality of virtual channels providing data to a receiver that has a substantial capacity to receive the data.

5. The method of claim 1, wherein determining the storage location of the data further comprises:
managing a tail pointer of a memory to indicate the storage location.

6. The method of claim 1, wherein packetizing the stored data in accordance with the first transmission protocol further comprises:
buffering the stored data to produce buffered data;
packetizing the buffered data in accordance with a HyperTransport (HT) protocol to produce HTpackets; and
elastic storing the HT packets.

7. The method of claim 1, wherein packetizing the stored data in accordance with the second transmission protocol further comprises:
buffering the stored data to produce buffered data;
packetizing the buffered data in accordance with a System Packet Interface (SPI) protocol to produce SPI packets; and
elastic storing the SPI packets.

8. An apparatus for transmitting data from a plurality of virtual channels, the apparatus comprises:
means for scheduling data from at least one of the plurality of virtual channels for transmission during a first transmission cycle;
means for determining storage location of the data from the at least one of the virtual channels during a second transmission cycle to produce a determined storage location; means for storing the data from the at least one of the virtual channels in the determined storage location during a third transmission cycle to produce stored data;
means for packetizing, during a fourth transmission cycle, the stored data in accordance with a first transmission protocol when the first transmission protocol is indicated; and
means for packetizing, during the fourth transmission cycle, the stored data in accordance with a second transmission protocol when the second transmission protocol is indicated.

9. The apparatus of claim 8, wherein the means for scheduling further functions to perform at least one of:
determining a weighting factor for each of at least some of the plurality of virtual channels to produce a plurality of weighting factors, wherein each of the plurality of weighting factors indicates, for a respective one of the at least some of the plurality of virtual channels, a backlog of data to transmit, and wherein the at least some of the plurality of virtual channels includes the at least one of the plurality of virtual channels; and
selecting the at least one of plurality of virtual channels based on the plurality of weighting factors and an bandwidth allocation policy.

10. The apparatus of claim 9, wherein the determining the weighting factor further comprises:
establishing the weighting factor for a particular one of the at least some of the plurality of virtual channels based on desired reception parameters of a receiver of the data from the particular one of the at least some of the plurality of virtual channels.

11. The apparatus of claim 9, wherein the bandwidth allocation policy further comprises at least one of:
weighted round robin allocation among the plurality of virtual channels;
starvation allocation policy that provides priority to one of the plurality of virtual channels having a potential loss of data; and
receiver availability allocation policy that provides priority to one of the plurality of virtual channels providing data to a receiver that has a substantial capacity to receive the data.

12. The apparatus of claim 8, wherein the means for determining the storage location of the data further functions to:
manage a tail pointer of a memory to indicate the storage location.

13. The apparatus of claim 8, wherein the means for packetizing the stored data in accordance with the first transmission protocol further functions to:
buffer the stored data to produce buffered data;
packetize the buffered data in accordance with a HyperTransport (HT) protocol to produce HT packets; and
elastic store the HT packets.

14. The apparatus of claim 8, wherein the means for packetizing the stored data in accordance with the second transmission protocol further functions to:
buffer the stored data to produce buffered data;
packetize the buffered data in accordance with a System Packet Interface (SPI) protocol to produce SPI packets; and
elastic store the SPI packets.

15. A multiple processor integrated circuit comprises:
a plurality of processing units;
cache memory;
memory controller operably coupled to system memory;
internal bus operably coupled to the plurality of processing units, the cache memory and the memory controller;
packet manager operably coupled to the internal bus;
node controller operably coupled to the internal bus;
first configurable packet-based interface;
second configurable packet-based interface; and
switching module operably coupled to the packet manager, the node controller, the first configurable packet-based interface, and the second configurable packet-based interface, wherein each of the first and second configurable packet-based interfaces include a input/output module and a media access control (MAC) layer module, wherein the MAC layer module includes:
means for scheduling data from at least one of the plurality of virtual channels for transmission during a first transmission cycle;
means for determining storage location of the data from the at least one of the virtual channels during a second transmission cycle to produce a determined storage location;
means for storing the data from the at least one of the virtual channels in the. determined storage location during a third transmission cycle to produce stored data;
means for packetizing, during a fourth transmission cycle, the stored data in accordance with a first transmission protocol when the first transmission protocol is indicated; and
means for packetizing, during the fourth transmission cycle, the stored data in accordance with a second transmission protocol when the second transmission protocol is indicated.

16. The multiple processor integrated circuit of claim 15, wherein the means for scheduling further functions to perform at least one of:
determining a weighting factor for each of at least some of the plurality of virtual channels to produce a plurality of weighting factors, wherein each of the plurality of weighting factors indicates, for a respective one of the at least some of the plurality of virtual channels, a backlog of data to transmit, and wherein the at least some of the plurality of virtual channels includes the at least one of the plurality of virtual channels; and
selecting the at least one of plurality of virtual channels based on the plurality of weighting factors and an bandwidth allocation policy.

17. The multiple processor integrated circuit of claim 16, wherein the determining the weighting factor further comprises:
establishing the weighting factor for a particular one of the at least some of the plurality of virtual channels based on desired reception parameters of a receiver of the data from the particular one of the at least some of the plurality of virtual channels.

18. The multiple processor integrated circuit of claim 16, wherein the bandwidth allocation policy further comprises at least one of:
weighted round robin allocation among the plurality of virtual channels;
starvation allocation policy that provides priority to one of the plurality of virtual channels having a potential loss of data; and
receiver availability allocation policy that provides priority to one of the plurality of virtual channels providing data to a receiver that has a substantial capacity to receive the data.

19. The multiple processor integrated circuit of claim 15, wherein the means for determining the storage location of the data further functions to:
manage a tail pointer of a memory to indicate the storage location.

20. The multiple processor integrated circuit of claim 15, wherein the means for packetizing the stored data in accordance with the first transmission protocol further functions to:
buffer the stored data to produce buffered data;
packetize the buffered data in accordance with a HyperTransport (HT) protocol to produce HT packets; and
elastic store the HT packets.

21. The multiple processor integrated circuit of claim 15, wherein the means for packetizing the stored data in accordance with the second transmission protocol further functions to:
buffer the stored data to produce buffered data;
packetize the buffered data in accordance with a System Packet Interface (SPI) protocol to produce SPI packets; and
elastic store the SPI packets.
